(19) United States
(12) Patent Application Publication
(10) Pub. No.: US 2002/0143919 A1
(43) Pub. Date: Oct. 3, 2002

(54) Network comprising a localization management

(76) Inventors: Jesus-Manuel Duque-Anton, Aachen (DE); Yonggang Du, Aachen (DE); Thomas Falck, Aachen (DE); Martin Stahl, Kaltenkirchen (DE)

Correspondence Address: Michael E. Marion, c/o PHILIPS ELECTRONICS NORTH AMERICA CORPORATION, Intellectual Property Deparment, 580 White Plains Road, Tarrytown, NY, 10591, US

(21) Appl. No.: 10/015,846

(22) Filed: Dec. 10, 2001

(30) Foreign Application Priority Data
Dec. 13, 2000 (DE) 10061958.4

(51) Int. Cl. G06F 15/173; G06F 15/16

(52) U.S. Cl. 709/223; 709/245

(57) ABSTRACT

The invention relates to a network comprising a plurality of switches which are combined to respective sub-networks and coupled to fixed terminals or, via base stations, to mobile terminals. Each switch comprises for the connection setup from a terminal to a mobile terminal at least a table which contains an assignment of the home address of a mobile terminal to its visitor's address and to the sub-network of the switch assigned to the mobile terminal.

The invention relates to a network comprising a plurality of sub-networks which each comprise a plurality of switches for exchanging messages with coupled fixed or mobile terminals. Localization management in such a network is defined as the search of a terminal for a mainly mobile terminal with which a connection is to be set up.

Such a network with a localization management is known from “Arup Archarya, Jun Li, Furquan Ansari and Dipankar Raychaudhuri: Mobility Support for IP over Wireless ATM, IEEE Communications Magazine, April 1998, pp. 84 to 88”. In this publication a terminal first tries to set up a connection to the home switch of a mobile terminal. If the terminal is not located at its home switch, however, the connection is set up again and a completely new connection is set up to the visitor's switch and thus to the mobile terminal.

It is an object of the invention to provide a network with which the connection setup is expedited.

The object is achieved in that the network comprises a plurality of switches which

are combined to respective sub-networks,

are coupled to fixed terminals or via base stations to mobile terminals,

contain for a respective connection setup from one terminal to a mobile terminal at least a table which contains an assignment of the home address of a mobile terminal to its visitor's address and to the sub-network that includes the switch assigned to the mobile terminal.

According to the invention the network is subdivided into sub-networks which each comprise a group of switches. Each switch contains a table stating not only the home addresses and visitor's addresses, but also an assignment as to what switches form part of the sub-network. Such an assignment may be made via a sub-network identification, which characterizes a sub-network. The table of a switch then contains an assignment of at least all the switches assigned to one sub-network identification. Based on this sub-network identification, a connection setup can then be made in a simpler and faster manner.

Claim 3 describes the composition of a home or visitor's address which consists of network information (identification of a home or visitor's switch) and terminal information (identification of a terminal).

Claims 4 and 6, respectively, indicate the two variants of a simplified connection setup. A first provisional connection to the sub-network switch that can be reached first is set up and then a second provisional connection to a switch.

In the first variant a provisional connection to the home switch is set up. If the home address of the mobile terminal does not correspond to its visitor's address at that moment, the second provisional connection is set up as is a connection to the visitor's switch. The speeding up is evident in that the provisional connection need not be completely set up anew in case of different home address and visitor's address.

In the second variant, no connection to the home switch is set up if home address and visitor's address are different. This is possible because each switch of a sub-network contains a visitor's table with an assignment via the visitor's addresses at that moment of all the mobile terminals assigned to the sub-network. The second provisional connection is set up to the visitor's switch if the switch that can be reached first reads from its visitor's table that the mobile terminal is visiting a switch of the home sub-network.

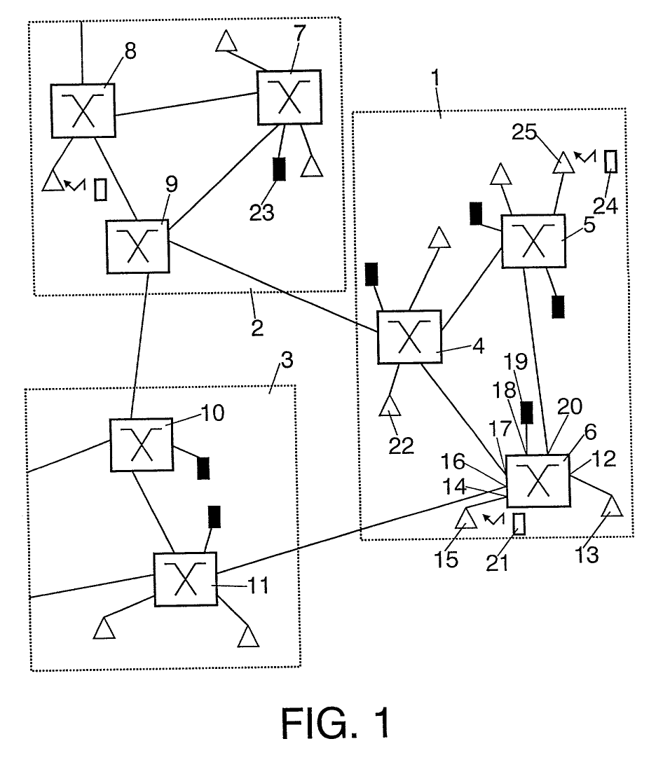

Examples of embodiment of the invention will be further explained with reference to FIG. 1 which shows a network comprising a plurality of sub-networks.

The network represented in FIG. 1 shows a plurality of sub-networks 1 to 3 which comprise a plurality of switches. The sub-network 1 comprises the switches 4 to 6, the sub-network 2 the switches 7 to 9 and the sub-network 3 the switches 10 and 11. A sub-network 1 to 3 may be, for example, a business network with one switch in each building. Each switch is coupled via access points or a port to another switch, to a base station or to a fixed or non-mobile terminal. The access points or ports represent inputs and outputs of a switch. For example, the switch 6 has six access points. The access point 12 is coupled to the base station 13, the access point 14 to a base station 15, the access point 16 to the switch 11, the access point 17 to the switch 4, the access point 18 to a fixed terminal 19 and the access point 20 to the switch 5. The base station 15 exchanges data or messages, respectively, with a mobile terminal 21 by radio path.

The network may be a communication system working in the asynchronous transfer mode (ATM), which is suitable for all services, for example, speech transmission, video signal distribution and data communication. The messages or information to be transmitted in the asynchronous transfer mode are packed into packets of the same length (cells), so that the communication system transmits packets of the same kind irrespective of the service or application used. A cell contains a header field of 5 bytes, which contains route or control information, and an information field of 48 bytes which contains data.

Prior to the transfer of the message or information (data transfer), a virtual link is set up by means of a signaling and cleared after the data transfer has finished. Between the terminal (user side) and the network (network side) is then made an agreement about the desired transmission properties such as bandwidth, error rate and delay.

How the user side (terminal) and the network side exchange data with each other and how these data are processed is determined by an interface definition. The interface between terminal and network is referred to as User-to-Network Interface, UNI for short. The ITU-standardized method Q.2931 is used for this purpose. The interface between two switches or also between two networks is referred to as Network-to-Network Interface, NNI for short.

For transmitting the signaling information, cells are used which are referred to as control cells. After a connection setup, when a virtual channel is rendered available for the transmission between two terminals, the user data are transported in cells which are referred to as user cells. The two types of cells may be distinguished via particular information in the header field of a cell. In a terminal and in a switch the two different data—signaling data and user data—are separately conveyed or channeled. Thus an ATM user channel can be defined for the transport of user data and an ATM signaling channel for the transport of signaling data.

Each fixed or mobile terminal has a unique address by which it distinguishes itself from the other terminals in the network. This address may comprise, for example, 20 bytes of which 13 bytes identify the network and 7 bytes the terminal, and characterizes the location at which the terminal is in the network. The part relating to the network may be, for example, an identification for a switch. In the following the identification for a switch is referred to as SID(i), i=0, 1, 2, . . . and an identification for a terminal as AID(n), n=0, 1, 2, . . . . The fixed terminal 19 can have the address SID(6).AID(19) and a mobile terminal 21 the address SID(6).AID(21). SID(6) is then the identification for the switch 6, AID(19) the identification for the fixed terminal 19 and AID(21) the identification for the mobile terminal 21. The address SID(6).AID(21) thus indicates that the terminal 21 having the identification AID(21) is assigned to the switch 6.

For the mobile terminals a distinction is further to be made between a static home address and a dynamic visitor's address. For example, the address SID(6).AID(21) is the home address of the mobile terminal 21. If the terminal 21 is located in the area of the switch 4, is thus connected via a base station 22 coupled to the switch 4, the terminal 21 having the home address SID(6).AID(21) has the visitor's address SID(4).AID(21).

According to the invention, a sub-network identification NID(k), k=0, 1, 2, . . . , is entered which features a sub-network and thus a group of switches. Such a sub-network identification is particularly advantageous for the mobile terminals to establish a connection to a mobile terminal in a simple manner. Also a home sub-network which has a certain sub-network identification NID(k) is thus assigned to a mobile terminal.

If a terminal attempts to set up a connection to a mobile terminal, first the home address is used for establishing the connection. The terminal then first forms a so-termed sub-path up to the first switch of the home sub-network of the mobile terminal if the terminal that wishes to have a connection to the mobile terminal is located outside the home sub-network of the mobile terminal. A sub-path is understood to mean a provisional connection which is not yet laid down. From this first switch is then extended a second sub-path to the home switch of the mobile terminal.

When the visitor's address at that moment of the mobile terminal does not correspond with its home address, the second sub-path is released. If the visitor's address of the mobile terminal is assigned to the home sub-network (is ascertained via the sub-network identification), thus the mobile terminal is located in the home sub-network, the second sub-path to the switch visited by the mobile terminal is established. After a successful acceptance by the mobile terminal, the two sub-paths are combined into one i.e. the connection setup is terminated. Only in the case where the visitor's address is not assigned to the home sub-network will the first sub-path be released and a new first path be set up to the switch visited by the mobile terminal at that instant.

This connection setup may be explained with the following example. A fixed terminal 23 which is coupled to the switch 7 in the sub-network 2 would like to set up a connection to a mobile terminal 24 which is coupled to the switch 5 of the sub-network 1 via a base station 25. The terminal 24 in this example has the home address SID(6).AID(24) and the visitor's address SID(5).AID(24) at that moment. Both the home address and the visitor's address are assigned to the sub-network 1. The sub-network identification is the same both for the home address and for the visitor's address, i.e. NID(1). First a first sub-path is created from the fixed terminal 23 via the switches 7 and 9 to the switch 4 of the sub-network 1.

The switch 4 ascertains that both itself and the home switch are assigned to the same home sub-network and then sets up a second sub-path to the home switch 6 of the mobile terminal 24. The switch 6, however, detects that the home address of the mobile terminal 24 does not correspond to the visitor's address for that moment. The switch 4 is informed of this, which switch then again clears the second sub-path and sets up a second sub-path to the switch 5. The switch 5 is then the switch visited by the mobile terminal 24.

Since the switches 4, 5 and 6 have all the same sub-network identification NID(1), only the second sub-path and not the first sub-path is to be set up anew.

For the above-described sub-paths to be set up or cleared, the switches comprise various functions and tables (or memories) respectively, which will be explained in the following.

Each switch contains a function which maps switches onto the sub-networks. This is realized, for example, with the aid of a sub-network table which contains at least a list of all the switches assigned to a sub-network. With a connection setup a switch then ascertains whether the switch to which a connection is to be set up forms part of its own sub-network (home sub-network, respectively).

To ensure which switch visits a mobile terminal at a particular moment, each switch contains a visitor's table. This visitor's table points from the home address to the visitor's address at that moment of a mobile terminal. This table may also have references from the home address to the visitor's address of the mobile terminal of all the switches of its home sub-network. In that case the connection setup can be accelerated, because a switch of a sub-network always has information about all the visitor's addresses of its home sub-network at particular moments.

If a mobile terminal moves from one radio cell to another, but which are both assigned to the same switch but to different base stations, this is referred to as an intraswitch handover. In such case neither the visitor's table nor the sub-network table is changed. However, switch routing tables not further explained here, which have stored information for the routing of the ATM cells (for example, to the access points), are changed.

If a mobile terminal moves from one radio cell to another, which, however, are assigned to different switches and thus to different base stations, this is referred to as an interswitch handover. In that case the visitor's address of a mobile terminal changes. Therefore, it is necessary for the visitor's tables in the various switches to be adapted accordingly. Also routing tables in the two different switches are to be changed.

This change of the visitor's address can be announced either by the mobile terminal or the visitor's switch to the home switch of the mobile terminal or, if all the switches of a sub-network have stored the visitor's addresses of all mobile terminals, to all the switches of the sub-network.

Intranet handover is understood to mean that a mobile terminal moves from one radio cell to another radio cell, which belongs to another sub-network. In that case also the visitor's tables are to be changed.

1. A network comprising a plurality of switches which
are combined to respective sub-networks,
are coupled to fixed terminals or via base stations to mobile terminals,
contain for a respective connection setup from one terminal to a mobile terminal at least a table which contains an assignment of the home address of a mobile terminal to its visitor's address and to the sub-network that includes the switch assigned to the mobile terminal.

2. A network as claimed in claim 1, characterized in that a sub-network identification features a sub-network and in that a table in a switch contains an assignment of at least all the switches assigned to a sub-network identification.

3. A network as claimed in claim 1, characterized in that the home address is in the form of an identification for a switch assigned to a terminal and an identification for the terminal and in that the visitor's address is formed by a combination of an identification for a switch visited at that moment by a mobile terminal and an identification for the mobile terminal.

4. A network as claimed in claim 1, characterized in that in case of a connection setup between a terminal and a mobile terminal, initially a first provisional connection is set up to a first switch of the home sub-network of the mobile terminal and then a second provisional connection to the home switch of the mobile terminal, in that, if the home address of the mobile terminal does not correspond with its visitor's address at that moment, the second provisional connection to the home switch is cleared and a second provisional connection to the visitor's switch is set up if the mobile terminal is visiting a switch of the home sub-network.

5. A network as claimed in claim 1, characterized in that each switch of a sub-network contains a visitor's table with an assignment via the visitor's addresses at that moment of all the mobile terminals assigned to the sub-network.

6. A network as claimed in claim 5, characterized in that when a connection is set up between one terminal and a mobile terminal initially a first provisional connection is set up to a first switch of the home sub-network of the mobile terminal and then a second provisional connection is set up to the visitor's switch if the first switch detects in its visitor's table that the mobile terminal is visiting a switch of the home sub-network.
